(19) United States
(12) Patent Application Publication
(10) Pub. No.: US 2024/0090492 A1
(43) Pub. Date: Mar. 21, 2024

(54) ERGONOMIC COLLAPSIBLE FLY SWATTING APPARATUS

(71) Applicant: Robert Hammond, Pompano Beach, FL (US)

(72) Inventor: Robert Hammond, Pompano Beach, FL (US)

(21) Appl. No.: 17/945,712

(22) Filed: Sep. 15, 2022

(51) Int. Cl. A01M 3/02

(52) U.S. Cl. CPC A01M 3/027

(57) ABSTRACT

An ergonomic collapsible fly swatting apparatus, including a gripping pad. The gripping pad having an anchor ring affixed to an apex of said gripping pad. The ergonomic collapsible fly swatting apparatus also including an elastic tether secured to the anchor ring of the gripping pad. The elastic tether rests in a constricted state, whereby said elastic tether gains stored energy when stretched by a user and accelerates toward and projects past said anchor ring when released by said user. The ergonomic collapsible fly swatting apparatus is capable of carrying in a user's pocket, and capable of launching a projecting element at high velocity capable of incapacitating a fly or other insect.

### FIELD OF THE INVENTION

The present invention relates to fly swatters and elastic projectile toys.

### BACKGROUND

Current fly swatting devices include an elongated handle with a square swatting pad at its tip. Typically, the handle is semi-flexible, but such flexing does not engage any stored energy to increase the speed at which the swatting pad strikes the targeted fly. In order to kill the targeted fly, the user must swing the swatting pad with the hopes that the velocity at which the pad strikes the fly employs less time than the reflexes by the fly. However, the speed is limited by the reflexes of the user of the fly swatter.

In addition, current fly swatting devices are bulky and not relatively portable. It is not possible to slip a typical fly swatter into one's pocket or a pouch of a bag. So-called collapsible fly swatters available in the market still employ a swatting pad to carry out the killing of the targeted fly, which are themselves bulky.

Thus, a need exists in the market for a fly killing device that is both compact, and capable of using stored energy to increase the velocity of the projected swatting surface.

### SUMMARY OF THE INVENTION

The invention disclosed herein provides an ergonomic collapsible fly swatting apparatus. The insect swatting apparatus includes a gripping pad. The gripping pad has an anchor ring affixed to the apex of the gripping pad. The insect swatting apparatus also includes an elastic tether secured to the anchor ring of the gripping pad, wherein the elastic tether rests in a constricted state. The elastic tether gains stored energy when stretched by a user and accelerates toward and projects past said anchor ring when released by said user.

It is an object of the present invention to provide a system capable of carrying in a user's pocket.

It is yet another object of the present invention is to provide a system capable of launching a projecting element at high velocity capable of incapacitating a fly or other insect.

It is a further object to provide a fly swatting apparatus with an ergonomic gripping element so that the swatter does not slip out of a user's hand when the projecting element is drawn back in a stretched position.

The drawings and specific descriptions of the drawings, as well as any specific or alternative embodiments discussed, are intended to be read in conjunction with the entirety of this disclosure. The invention may be embodied in many different forms and should not be construed as being limited to the embodiments set forth herein; rather, these embodiments are provided by way of illustration only and so that this disclosure will be thorough, complete and fully convey understanding to those skilled in the art. The above and yet other objects and advantages of the present invention will become apparent from the hereinafter set forth Brief Description of the Drawings, Detailed Description of the Invention, and Claims appended herewith.

### BRIEF DESCRIPTION OF THE DRAWINGS

FIG. 1 illustrates an isometric view of an ergonomic collapsible fly swatting apparatus.

FIG. 2 illustrates a side view of the ergonomic collapsible fly swatting apparatus.

FIG. 3 illustrates a top view of the ergonomic collapsible fly swatting apparatus without the elastic tether attached.

FIG. 4 illustrates a top view of the ergonomic collapsible fly swatting apparatus with the elastic tether attached.

FIG. 5 illustrates the ergonomic collapsible fly swatting apparatus in use by a user with the tether in a stretched state

FIG. 6 illustrates the ergonomic collapsible fly swatting apparatus with the tether released striking an insect.

FIG. 7 illustrates an embodiment of an ergonomic collapsible fly swatting apparatus with a unique outline.

FIG. 8 illustrates an embodiment of an ergonomic collapsible fly swatting apparatus with a unique outline.

FIG. 9 illustrates an embodiment of an ergonomic collapsible fly swatting apparatus with a unique outline.

FIG. 10 illustrates an embodiment of an ergonomic collapsible fly swatting apparatus with a unique outline.

FIG. 11 illustrates an embodiment of an ergonomic collapsible fly swatting apparatus with a unique outline.

FIG. 12 illustrates an embodiment of an ergonomic collapsible fly swatting apparatus with a unique outline.

FIG. 13 illustrates an embodiment of an ergonomic collapsible fly swatting apparatus with a unique outline.

FIG. 14 illustrates an embodiment of an ergonomic collapsible fly swatting apparatus with a unique outline.

FIG. 15 illustrates an embodiment of an ergonomic collapsible fly swatting apparatus with a unique outline.

### DETAILED DESCRIPTION OF THE INVENTION

The invention herein provides a solution for creating a compact, collapsible, flexible fly swatter with ergonomic gripping element capable of projecting a swatting surface at high velocity, and many other problems that can arise in the field of fly swatters. The invention includes a uniquely configured gripping pad 102 coupled to an elastic tether 106 capable of solving the above issues.

Current fly swatting devices include an elongated handle with a square swatting pad at its tip. Typically, the handle is semi-flexible, but such flexing does not engage any stored energy to increase the speed at which the swatting pad strikes the targeted fly. In order to kill the targeted fly, the user must swing the swatting pad with the hopes that the velocity at which the pad strikes the fly employs less time than the reflexes by the fly. However, the speed is limited by the reflexes of the user of the fly swatter.

In addition, current fly swatting devices are bulky and not relatively portable. It is not possible to slip a typical fly swatter into one's pocket or a pouch of a bag. So-called collapsible fly swatters available in the market still employ a swatting pad to carry out the killing of the targeted fly, which are themselves bulky.

The current invention solves these problems by incorporating a compact design, whereby the footprint is defined by the surface area of the gripping pad. This footprint is configured for size to fit in a user's hand. The elastic tether is inconsequential in overall footprint because it is thin and contracts in size. This allows the swatter to be compact and portable, fitting in the pocket of a user. The tether can also be replaced in case the tether snaps or if a longer or shorter tether is needed. Tethers can also be cut to size. Further, the gripping pad employs an asymmetrical design which naturally produces curves and cervices that help a user grip the gripping pad by providing an edge for a user's fingers to tug against. To assist, the gripping pad is also made of rubber which may flex and compress under a user's grip. The use of rubber also allows the gripping pad to flex, which eliminates the issues with plastic deformation when bending most common fly swatters.

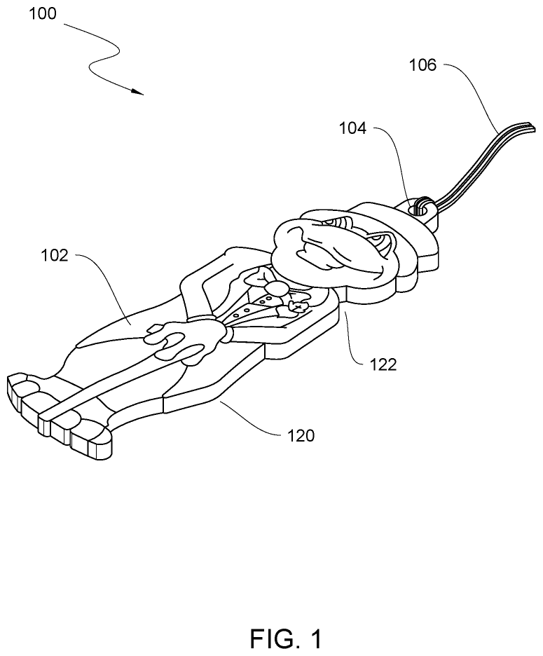

The fly swatters of the present invention may be used to incapacitate flies and other insects, or may be employed for games where the user targets and strikes a targeted object. This apparatus and system are particularly shown in FIGS. 1-15.

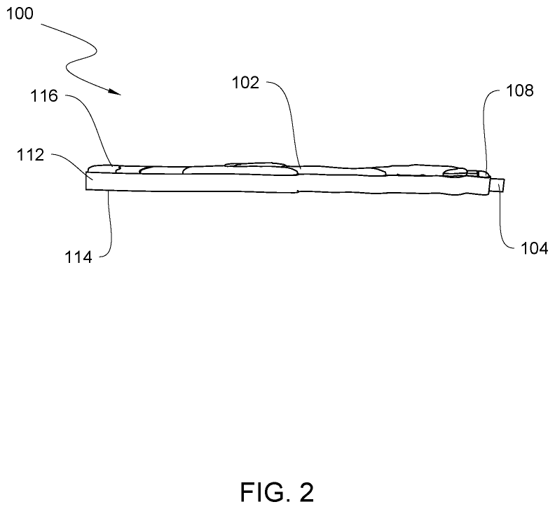

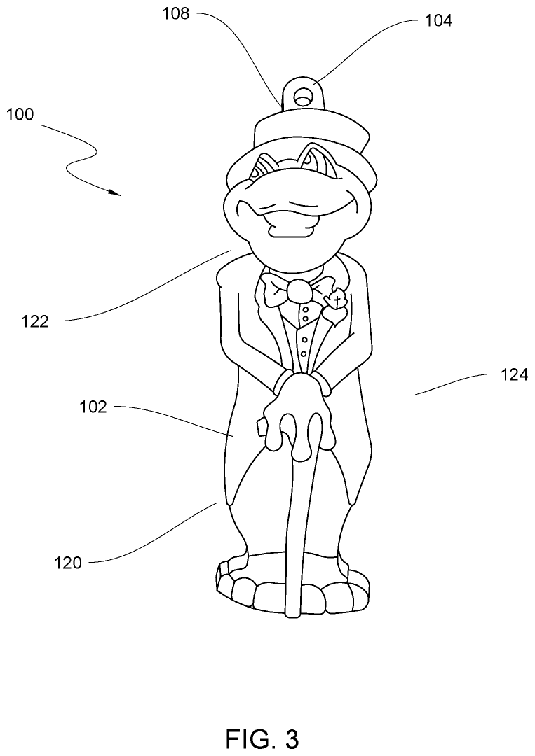

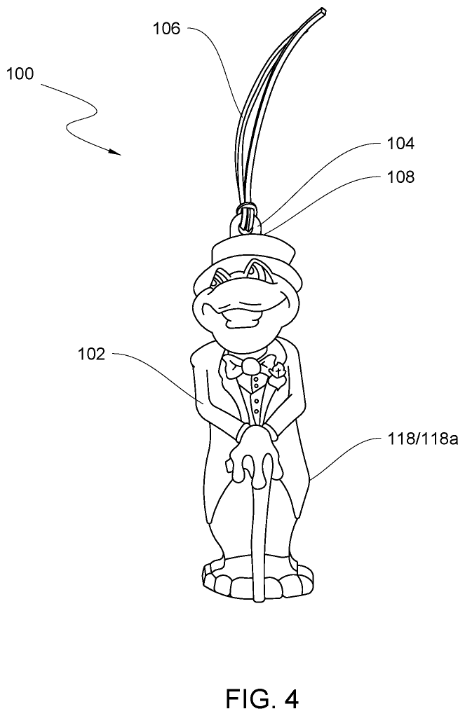

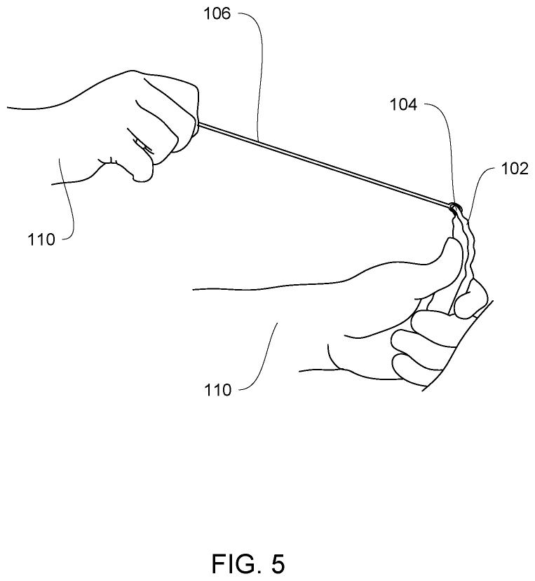

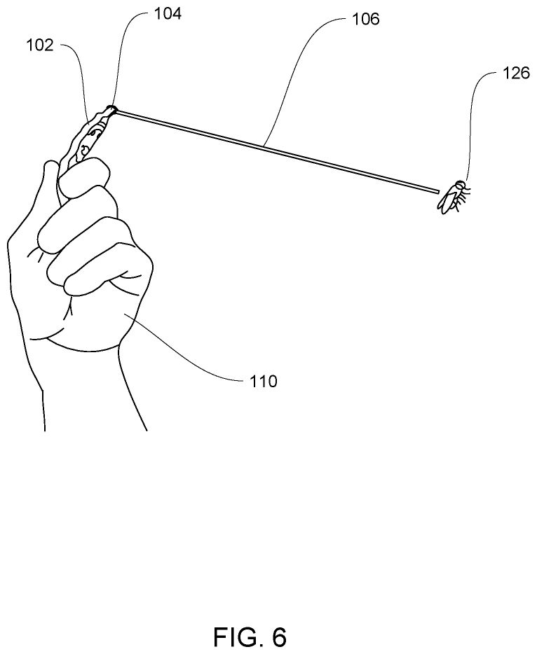

FIG. 1 illustrates an isometric view of an ergonomic collapsible fly swatting apparatus 100. FIG. 2 illustrates a side view of the ergonomic collapsible fly swatting apparatus 100. The multiple layers 112, 114, 116 may be appreciated from FIG. 2. FIG. 3 illustrates a top view of the ergonomic collapsible fly swatting 100 apparatus without the elastic tether attached to the anchor ring 104. FIG. 4 illustrates a top view of the ergonomic collapsible fly swatting apparatus with the elastic tether 106 attached to the anchor ring 104. FIG. 5 illustrates the ergonomic collapsible fly swatting apparatus 100 in use by a user 110 with the tether 106 in a stretched state. FIG. 6 illustrates the ergonomic collapsible fly swatting apparatus 100 with the tether 106 released striking an insect 126.

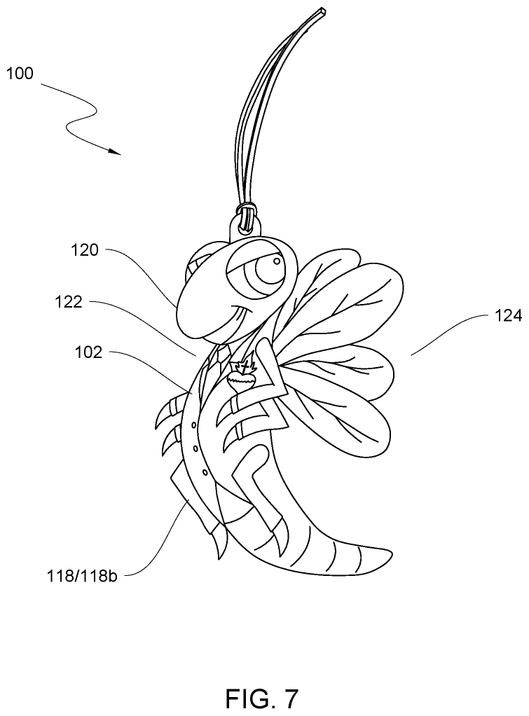

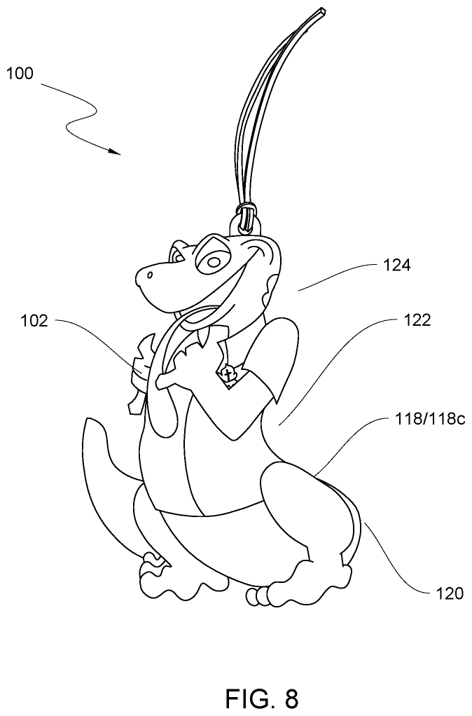

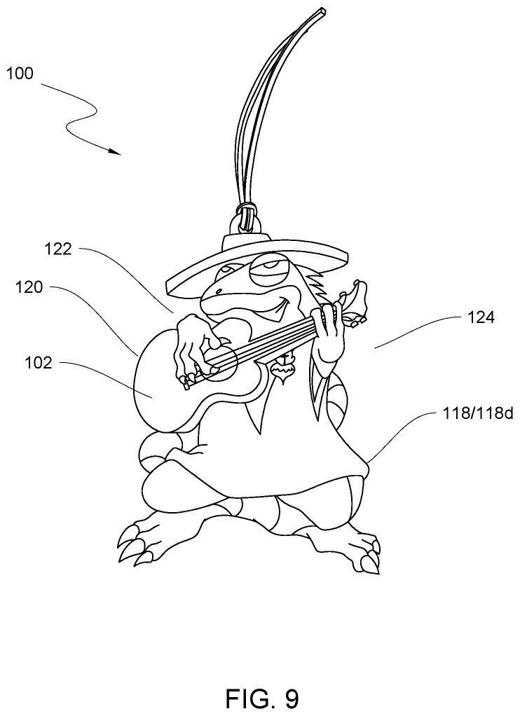

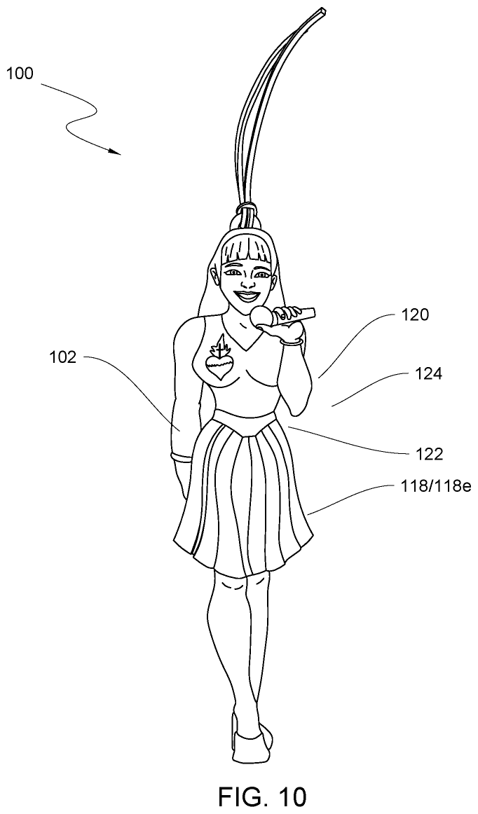

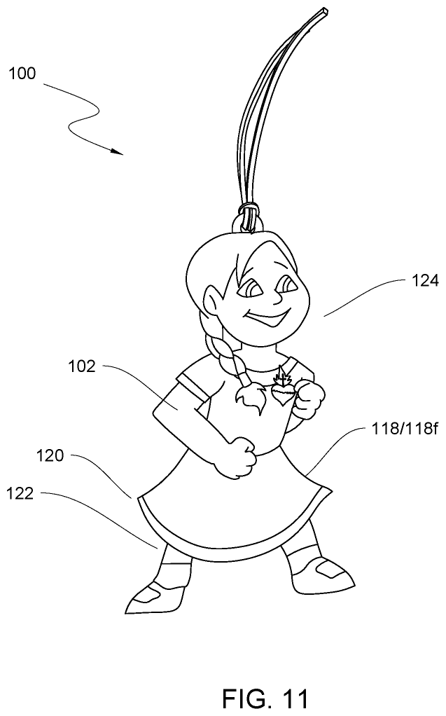

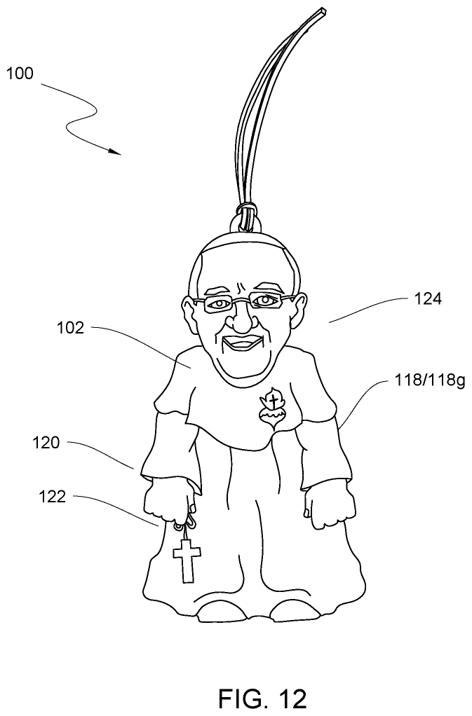

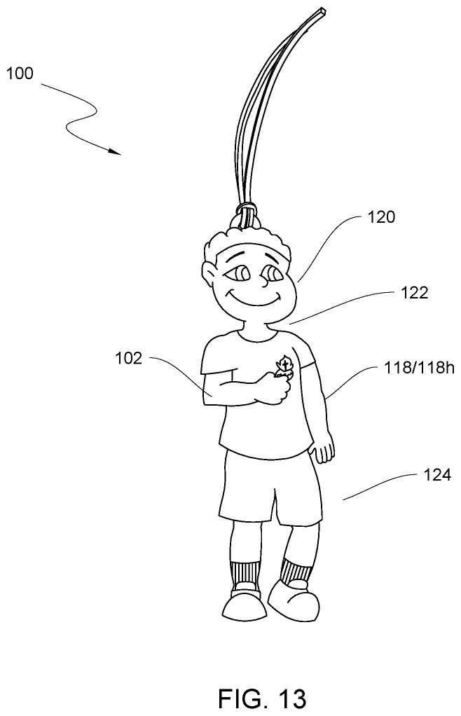

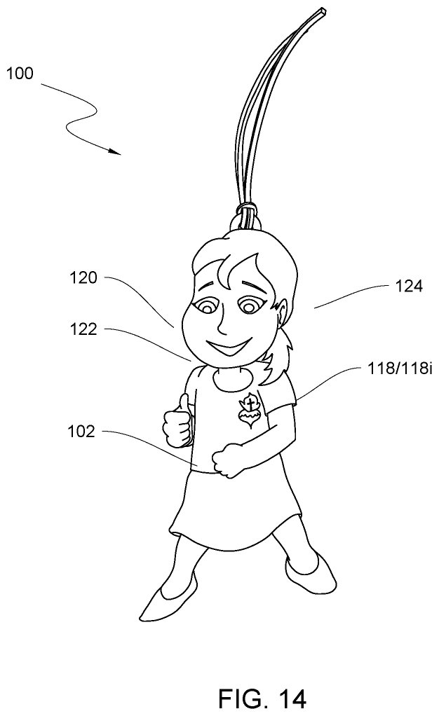

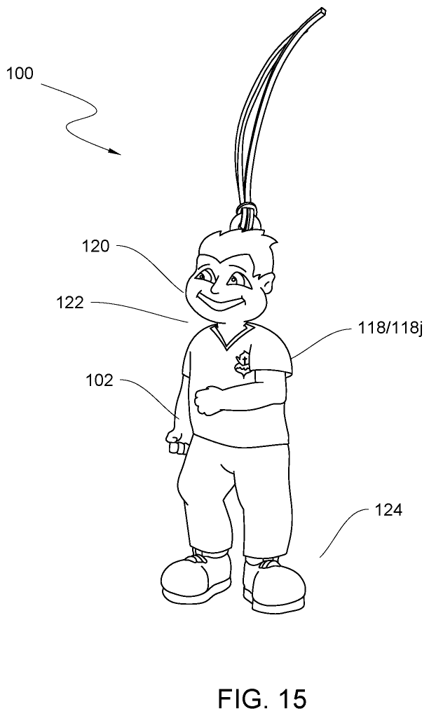

FIGS. 7-15 illustrate variations in embodiments having different outlines 118. FIG. 7 illustrates an embodiment of an ergonomic collapsible fly swatting apparatus 100 with a unique outline 118b. FIG. 8 illustrates an embodiment of an ergonomic collapsible fly swatting apparatus 100 with a unique outline 118c. FIG. 9 illustrates an embodiment of an ergonomic collapsible fly swatting apparatus 100 with a unique outline 118d. FIG. 10 illustrates an embodiment of an ergonomic collapsible fly swatting apparatus 100 with a unique outline 118e. FIG. 11 illustrates an embodiment of an ergonomic collapsible fly swatting apparatus 100 with a unique outline 118f. FIG. 12 illustrates an embodiment of an ergonomic collapsible fly swatting apparatus 100 with a unique outline 118g. FIG. 13 illustrates an embodiment of an ergonomic collapsible fly swatting apparatus 100 with a unique outline 118h. FIG. 14 illustrates an embodiment of an ergonomic collapsible fly swatting apparatus 100 with a unique outline 118i. FIG. 15 illustrates an embodiment of an ergonomic collapsible fly swatting apparatus 100 with a unique outline 118j.

In an exemplary embodiment, an ergonomic collapsible fly swatting apparatus 100 includes a gripping pad 102 and an elastic tether 104. The gripping pad 102 has an anchor ring 104 affixed to an apex 108 of the gripping pad 102. The elastic tether 106 secures to the anchor ring 104 of the gripping pad 102. The elastic tether 106 rests in a constricted state, as shown in FIGS. 1 and 4, whereby the elastic tether 106 gains stored energy when stretched by a user 110 as shown in FIG. 5 and accelerates toward and projects past said anchor ring 104 when released by said user 110, as shown in FIG. 6.

In most embodiments, the gripping pad 102 is constructed of a flexible compressible material capable of allowing for ergonomic gripping of a user. In some embodiments, this flexible compressible material is a multi-layered rubber, as shown in FIG. 2. The gripping pad 102 shown is constructed of a structural rubber layer 112, a compressible and flexible rubber layer 114, and a rubber layer configured to receive an ornamental design 116. Use of rubber is an important aspect of many embodiments because it allows a degree of flex when the tether 106 is stretched. It also compresses slightly allowing a user to keep a tight grip on the gripping pad 102. Further, unlike plastic fly swatters, which may experience a plastic deformation when bent beyond a certain threshold, a rubber gripping element 102 allows for a higher degree of stored energy without breaking, allowing a higher velocity of the projecting surface, which provides for better efficiency in outpacing a fly or insect.

In some embodiments, the gripping pad 102 is geometrically defined by an asymmetrical outline 118 providing curves 120 and cervices 122 to provide users with gripping elements 124. The curves 120 and cervices 122 are implemented by outlining a border 118 of an asymmetrical ornamental design. FIGS. 4 and 7-15 show a variety of different potential asymmetrical outlines 118a, 118b, 118c, 118d, 118e, 118f, 118g, 118h, 118i, 118j. While the designs themselves may be ornamental, the outlines provide curves 120 and crevices 122 that provide for gripping surfaces 124 for a user to grab on to, to keep the gripping pad 102 from slipping when pulled in tension by a stretched tether 106. The outlines 118a, 118b, 118c, 118d, 118e, 118f, 118g, 118h, 118i, 118j provide this functional benefit.

Because of the force of tension pulling on the anchor ring 104, the anchor ring 104 needs to be capable of withstanding at least a force of tension exceeding the elastic limit of the material for said elastic tether 106. In some embodiments the anchor ring 104 is affixed to said gripping pad 102, while in others the anchor ring 104 is unitarily formed with said gripping pad 102. In some embodiments, the elastic tether 106 is removably attached to said anchor ring 104. Allowing the tether 106 to removably attach to the gripping pad 102 by an anchor ring 104 allows the user to modify or replace the tether 106 in instances where a longer or shorter tether 106 is needed, or if the tether 106 breaks. However, it should be appreciated that in some embodiments, the tether 106 may be unitarily formed to the gripping pad 102.

In some embodiments, the invention provides a system for an ergonomic collapsible fly swatting apparatus 100, comprising a pouch for containing a fly swatter apparatus 100, a plurality of removably attachable elastic tethers 106, a fly swatter apparatus 100 having a gripping pad 102 constructed of a flexible compressible material capable of allowing for ergonomic gripping of a user and an removably attached elastic tether 106, wherein said gripping pad has an anchor ring 104 affixed to an apex 108 of said gripping pad 102, and said removably attached elastic tether 106 is secured to said anchor ring 104 of said gripping pad 102, wherein said removably attached elastic tether 106 rests in a constricted state, whereby said removably attached elastic tether 106 gains stored energy when stretched by a user and accelerates toward and projects past said anchor ring 104 when released by said user, wherein said gripping pad 102 is constructed of a multi-layered rubber including a structural rubber layer 112, a compressible and flexible rubber layer 114, and a rubber layer configured to receive an ornamental design 116, wherein said gripping pad 102 is geometrically defined by an asymmetrical outline providing curves 120 and cervices 122 to provide users with gripping elements 124, wherein the curves 120 and cervices 122 are implemented by outlining a border of an asymmetrical ornamental design, and wherein said anchor ring 104 is capable of withstanding at least a force of tension exceeding the elastic limit of the material for said elastic tether. While the elements of a pouch and a plurality of tethers are not specifically shown in the figures, additional figures beyond FIGS. 1-15 aren't necessary because a person of skill in the art should be able to understand the system embodiment from the embodiments disclosed in FIGS. 1-15. That is, the pouch itself does not recite any unique features that could not be understood from employing a generic definition of “pouch”, and tethers 106 are shown in FIGS. 1 and 4-15, one need only multiply the number of tethers 106, which does not change the disclosed characteristics or add unique features.

While there has been shown and described above the preferred embodiment of the instant invention it is to be appreciated that the invention may be embodied otherwise than is herein specifically shown and described and that certain changes may be made in the form and arrangement of the parts without departing from the underlying ideas or principles of this invention as set forth in the Claims appended herewith.

I claim:

1. An ergonomic collapsible fly swatting apparatus, comprising:
a gripping pad;
said gripping pad having an anchor ring affixed to an apex of said gripping pad; and
an elastic tether secured to said anchor ring of said gripping pad, wherein said elastic tether rests in a constricted state, whereby said elastic tether gains stored energy when stretched by a user and accelerates toward and projects past said anchor ring when released by said user.

2. The ergonomic collapsible fly swatting apparatus, as recited in claim 1, wherein said gripping pad is constructed of a flexible compressible material capable of allowing for ergonomic gripping of a user.

3. The ergonomic collapsible fly swatting apparatus, as recited in claim 2, wherein said gripping pad is constructed of a multi-layered rubber.

4. The ergonomic collapsible fly swatting apparatus, as recited in claim 3, wherein said gripping pad is constructed of a structural rubber layer, a compressible and flexible rubber layer, and a rubber layer configured to receive an ornamental design.

5. The ergonomic collapsible fly swatting apparatus, as recited in claim 1, wherein said gripping pad is geometrically defined by an asymmetrical outline providing curves and cervices to provide users with gripping elements.

6. The ergonomic collapsible fly swatting apparatus, as recited in claim 5, wherein the curves and cervices are implemented by outlining a border of an asymmetrical ornamental design.

7. The ergonomic collapsible fly swatting apparatus, as recited in claim 1, wherein said anchor ring is capable of withstanding at least a force of tension exceeding the elastic limit of the material for said elastic tether.

8. The ergonomic collapsible fly swatting apparatus, as recited in claim 1, wherein said anchor ring is affixed to said gripping pad.

9. The ergonomic collapsible fly swatting apparatus, as recited in claim 1, wherein said anchor ring is unitarily formed with said gripping pad.

10. The ergonomic collapsible fly swatting apparatus, as recited in claim 1, wherein said elastic tether is removably attached to said anchor ring.

11. A system for an ergonomic collapsible fly swatting apparatus, comprising:
a pouch for containing a fly swatter apparatus;
a plurality of removably attachable elastic tethers;
a fly swatter apparatus having a gripping pad constructed of a flexible compressible material capable of allowing for ergonomic gripping of a user and an removably attached elastic tether, wherein said gripping pad has an anchor ring affixed to an apex of said gripping pad, and said removably attached elastic tether is secured to said anchor ring of said gripping pad, wherein said removably attached elastic tether rests in a constricted state, whereby said removably attached elastic tether gains stored energy when stretched by a user and accelerates toward and projects past said anchor ring when released by said user;
wherein said gripping pad is constructed of a multi-layered rubber including a structural rubber layer, a compressible and flexible rubber layer, and a rubber layer configured to receive an ornamental design;
wherein said gripping pad is geometrically defined by an asymmetrical outline providing curves and cervices to provide users with gripping elements, wherein the curves and cervices are implemented by outlining a border of an asymmetrical ornamental design; and
wherein said anchor ring is capable of withstanding at least a force of tension exceeding the elastic limit of the material for said elastic tether.
